(19) United States
(12) Patent Application Publication
(10) Pub. No.: US 2016/0271771 A1
(43) Pub. Date: Sep. 22, 2016

(54) Wrench apparatus

(71) Applicant: BRIAN HARKER, GRANGER, IN (US)

(72) Inventor: BRIAN HARKER, GRANGER, IN (US)

(21) Appl. No.: 14/545,041

(22) Filed: Mar. 19, 2015

(51) Int. Cl. B25B 23/10; B25B 13/06

(52) U.S. Cl. CPC B25B 23/108; B25B 13/06

(57) ABSTRACT

An assembly of the spaced apart cam pins (or longitudinal arms) for a wrench is provided which is radially biased with respect to the workpiece opening and retained by metal spring elements formed in circumferential rings, spaced apart along the length of the arms, and acting upon adjacent arms. These spring rings are protected by intervening retention rings used to secure the assembly into the wrench housing. One or more of the spring rings can be secured to the end face of the arms, by a locking interface with notches in the end faces. A circumferential ring used intermediate the end faces of an arm can use a dimension reduction of the arm cross section in order to secure the arm. Alternatively, using spring rings at each end of the arms, with a shielding retention ring adjacent each spring ring, permits the camming functionality of the assembly to be readily utilized in more conventional wrenches.

### BACKGROUND OF THE INVENTION

The present invention relates to workpiece engaging apparatus, and more particularly to wrenches of various types, including socket wrenches. The present invention is intended to improve upon the invention disclosed in U.S. Pat. No. 7,290,467, entitled a “Socket Wrench Apparatus,” by the same inventor. In addition to providing improvements to the socket wrench apparatus shown in that prior patent, the present invention is intended to allow the teachings of that prior patent to be more readily adapted to wrenches and tool or workpiece holders of other types and configurations.

The teachings and content of the '467 are expressly incorporated herein by reference as if fully set forth herein as well. In particular, the present invention teaches the use of a different web/cam pin assembly, which can be used in place of that shown in FIGS. 6 and 7 of the '467 patent. The general purpose, structure, and function of the invention are the same as that described in the '467 patent, except as is indicated herein.

Briefly, and by reference to the '467 patent, the web/cam pin assembly of that patent included a web 36 formed of resilient material, such as the plastic material indicated in that '467 patent, which connected to and retained longitudinally extending members 40, typically referred to as cam pins or longitudinal arms. These arms 40 included notches or reduced areas 42, intermediate the ends of the arms, which served to allow web 36 to hold the arms in place. The overall orientation of the web/cam pin assembly was as a longitudinally extending cylinder about axis AA, as shown in FIG. 1 of the '467 patent.

Commercial embodiments of the invention taught by the '467 patent have been successful and widely adopted. However, experience through the years of such products has shown that in certain instances the invention does not work as well as would be desired. For example, it has been found to be not uncommon practice for workers faced with extensively rusted or corroded bolts to first attempt to loosen the bolt by heating it with a torch or similar device. Once so heated, the bolt (and/or a nut attached to it) retains that heat for a significant period of time. When wrenches using the invention of the '467 patent are then applied to the heated workpiece (either to the bolt head or the nut), a substantial thermal gradient exists between the temperature of the workpiece and the temperature of the wrench. That thermal gradient has been found, on occasion, to be sufficient to degrade the performance of the plastic web holding the cam pins or arms in place, occasionally to the point of even melting or burning the web up and allowing the arms to fall out of the wrench after the workpiece is removed.

Obviously, the same problem could theoretically occur as a result of merely using wrenches of that type in elevated temperatures where the thermal gradient was zero, except that such wrenches are not normally stored at such elevated temperatures or readily used in such environments. However, the reverse problem has been noted as a potential, i.e., when wrenches of the type taught by the '467 patent are used a substantially lower temperatures than the particular plastic selected for use as web 36 was designed for. This could occur, for example, in extreme Northern climates or during periods of substantially lower than normal outdoor temperatures, where the plastic material of web 36 could become brittle or have substantially reduced elasticity.

Also, the construction of the wrench taught by the '467 patent, while efficient and economical in design, could be vulnerable to damage caused by less careful use. For example, in the construction illustrated in the '467 patent, the plastic web was directly accessible to the exterior environment by any object capable of entering the open end of the socket wrench. Sharp objects doing so could scratch or cut the web in part. Occasionally, the workpiece being used with the wrench could have such surfaces or projections thereon which impact and damage the web, especially over an extended period of use. Similarly, sand, crystalline materials, and like debris could also contact the web through the open end of the socket wrench, if, for example, the wrench was dropped onto such materials. Excessive instances of that happening could eventually degrade the functional capabilities of the wrench. Further, users may on occasion use certain solvents on stuck bolts or work pieces prior to applying wrenches of the type taught by the '467 patent. Depending upon the chemical nature of the solvent and of the plastic material selected for web 36, there may be an adverse chemical reaction which degrades the web if that solvent is allowed to contact the web.

Moreover, while the specific plastic material suggested for web 36 in the '467 patent may be suitable for most applications, there are practical limits to the strength of plastic materials, given the cost of certain plastic compositions and the compressibility needed to be assembled into the wrench and flex upon workpiece insertion. A plastic web may not permit higher forces to be applied to the wrench in certain circumstances, without driving production costs too high for effective marketing.

In other situations the sheer mass of the plastic needed for the web can be an issue. When applying the invention of the '467 patent to rather small wrenches or tool holders, the extent of compression and/or tension available to the web because of the reduced size or mass of the web can significantly reduce the preferred degree of functionality. Similarly, the dimensional extent of notches 42 in arms 40 that are often required for the web to most effectively engage and retain arms 40 can, on occasion, significantly reduce the strength available for those arms.

Further, it has been found that over time and in certain instances, the utilization of a single web member for biasing the cam pins or arms, positioned where it is, can permit permanent deformation or “bending” of portions of the wrench components which degrades overall performance. In addition, as with any product, it is always desirable to find ways to assemble the product more efficiently and reduce production costs. Also, the specific structural format taught in the '467 patent, is not readily adaptable to as wide a range of tools as would be desired, particularly because of the web configuration and the formats available for retaining that configuration into applicable housings.

Accordingly, it is an object of the present invention to provide an improved method and apparatus for workpiece manipulation. More specifically, objects of the present invention include providing a wrench system or workpiece holder which:
a. has improved functionality over a greater range of temperatures,
b. is more durable over time,
c. has improved resistance to degradation of performance over a wider range of usage environments and user practices,
d. is usable with a wider range of application force,
e. is easier to manufacture and can be manufactured at lower costs, and
f. is more readily adapted to a wide variety of workpiece holders.

### SUMMARY OF THE INVENTION

These and other objects of the present invention are obtained by the provision of an assembly of the spaced apart cam pins (or longitudinal arms) for the wrench which is radially biased and retained by metal spring elements formed in circumferential rings, spaced apart along the length of the arms, and acting upon adjacent arms. These spring rings are protected by intervening retention rings used to secure the assembly into the wrench housing. One or more of the spring rings can be secured to the end face of the arms, by a locking interface with notches in the end faces. A circumferential ring used intermediate the end faces of an arm can use a dimension reduction of the arm cross section in order to secure the arm. Alternatively, using spring rings at each end of the arms, with a shielding retention ring adjacent each spring ring, permits the camming functionality of the assembly to be readily utilized in more conventional wrenches.

Other objects, advantages, and novel features of the present invention will become more readily apparent from the following drawings and detailed description of preferred embodiments of this invention.

### BRIEF DESCRIPTION OF THE DRAWINGS

FIG. 1 is an exploded, front perspective view of a socket wrench socket embodying the present invention.

FIG. 2 is a cross sectional view of the embodiment of FIG. 1, as assembled.

FIG. 3 is a front end view of the embodiment of FIG. 1, as assembled.

FIG. 4 is a front perspective view of the web/arm assembly of the embodiment of FIG. 1, removed from the socket wrench.

FIG. 5 is a front end view of the web/arm assembly of the embodiment of FIG. 1.

FIG. 6 is a front perspective view of a single arm of the embodiment of FIG. 1.

FIG. 7 is an exploded, front perspective view of an alternative wrench embodying the present invention.

FIG. 8 is a cross sectional view of the embodiment of FIG. 7, as assembled.

FIG. 9 is a front perspective view of the web/arm assembly of the embodiment of FIG. 7.

The drawings are not intended to be to scale from one drawing to the next, some enlargement being used to facilitate understanding of the invention.

### DETAILED DESCRIPTION OF PREFERRED EMBODIMENTS

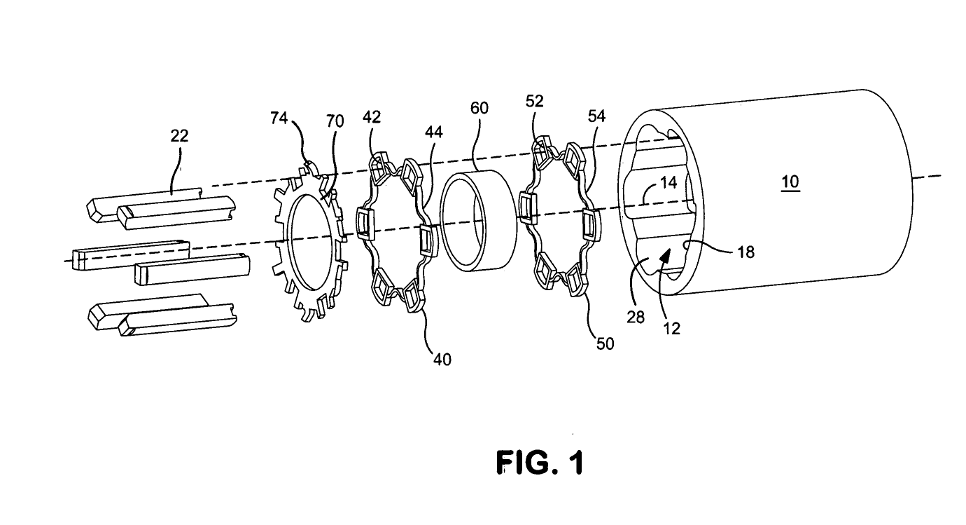

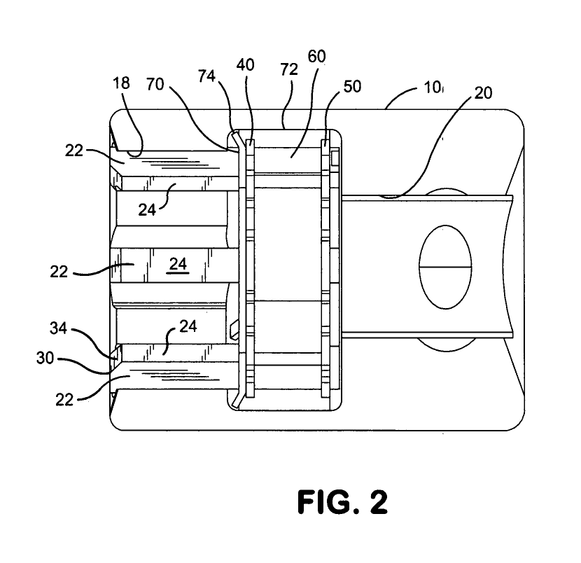

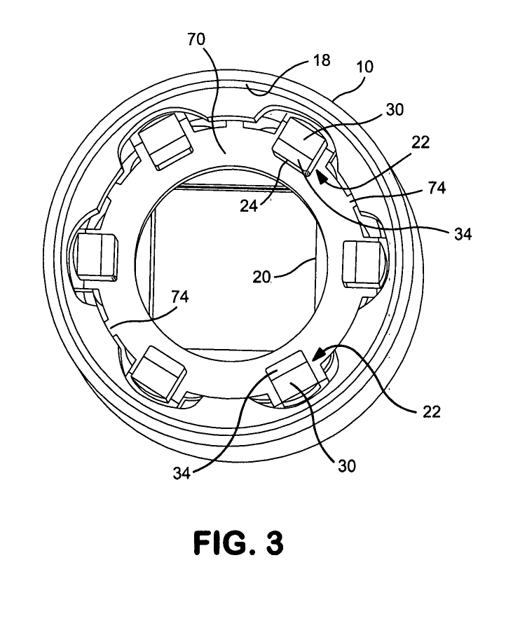

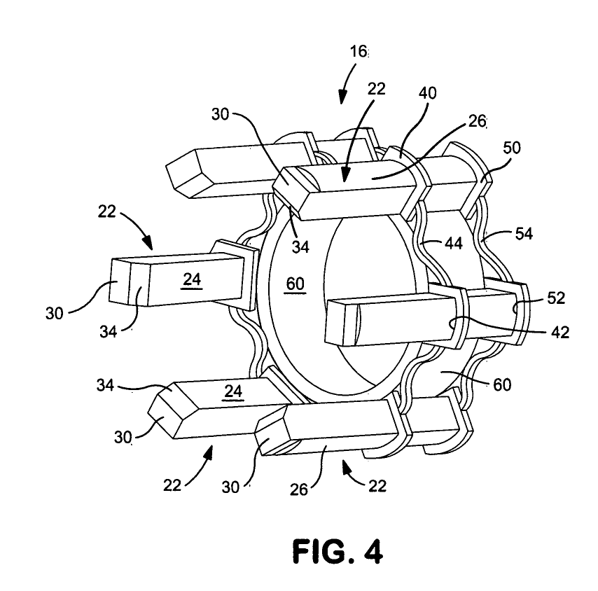

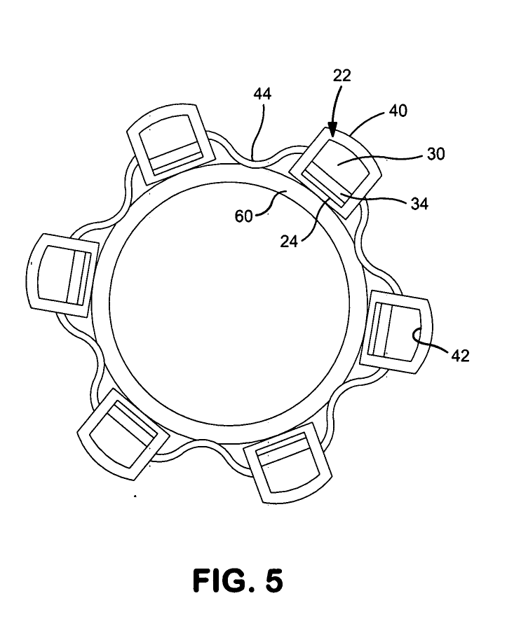

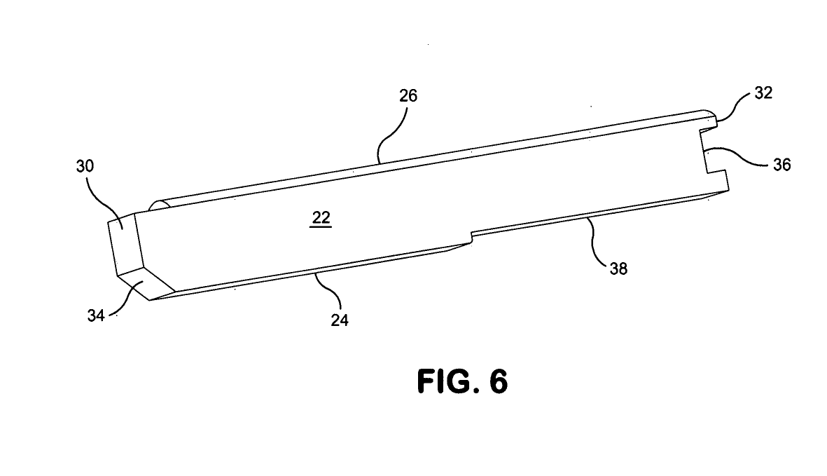

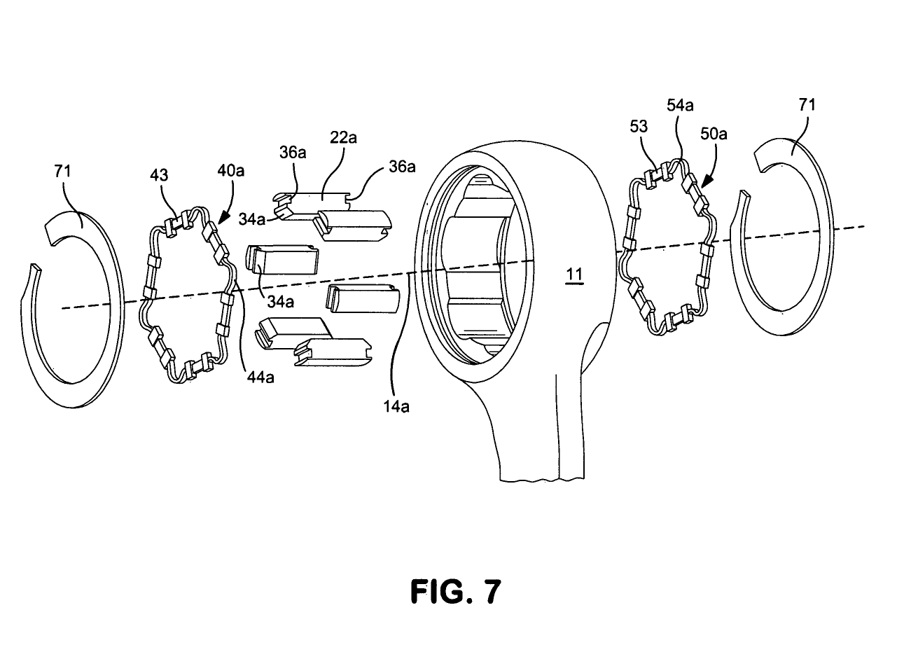

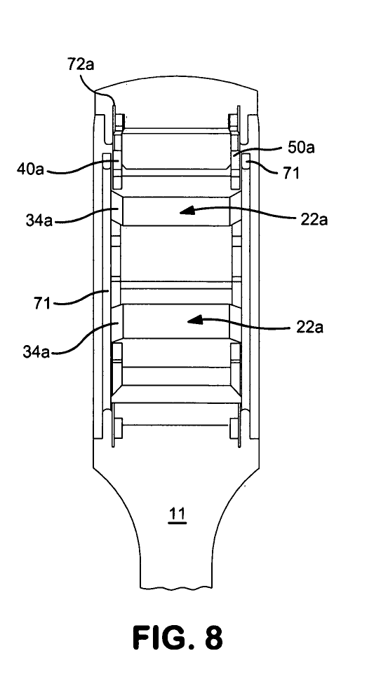

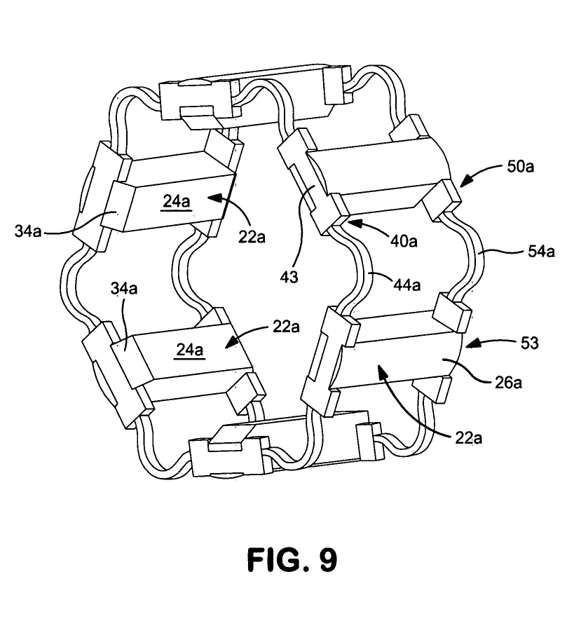

FIGS. 1-6 show one embodiment of the present invention, in the format of a socket wrench of the type shown in th '467 patent. FIGS. 7-9 show an alternative embodiment of the present invention in a different type of wrench 11, but with similar invention functionality as was taught in the '467 patent. The present invention expressly contemplates applications in a wide variety of wrench and tool holder types, where ever the functional attributes of this invention are desirable (and those functional attributes are elaborated upon herein and in the '467 patent). Moreover, even within each of these two illustrated embodiments of wrench types, there are significant alternative embodiments envisioned by the present invention.

For example, comparing the spring rings shown with respect to the two wrench types, concave springs are shown with FIG. 1 while convex springs are shown with FIG. 7, but either type of spring can be used with either wrench type. Also, in FIG. 1 the spring rings are shown with both spring rings being intermediate the ends of the arms. However, the present invention also envisions the spring rings of that embodiment could use one intermediate the ends of the arms and the other at a notched end face, such as is used in the embodiment of FIG. 7. Similarly, in FIG. 1 the retaining ring has a plurality of circumferential projections to engage the interior wall of the socket housing, but in FIG. 7 the retaining ring is of a split ring format which is radially compressible and biased to exert retention force over its entire circumference. Either type of ring can be used with either wrench type, as preferred in a given manufacture. Further, the spacer in FIG. 1 is illustrated to be a separate element from the spring rings, but in alternative embodiments that element can be formed integrally with one or more of the spring rings. Similarly, the need for a spacer is absent in the embodiment of FIG. 7 since the function of that element is inherent in the arms themselves because of the end face mounting, in other embodiments the need for a separate spacer element can be absent as well because of integration of that function in the cross section dimensional configuration of the arms or, in the case of embodiments using only a single spring ring, of the passageway through or interior wall of the socket housing.

Accordingly, the detailed discussion herein should not be considered to be an enumeration of the only embodiments applicable or contemplated for the present invention.

Briefly, FIG. 1 shows a socket body or housing 10 of a socket wrench wherein the assembly of the present invention can be mounted. Housing 10 includes a passageway 12 which extends at least partially (and preferably completely) through the housing along longitudinal axis 14. As explained in the '467 patent, and as shown in the drawings of this application, that passageway is configured with slots and/or recesses to receive the web/cam pin or web/arm assembly 16. Opening 18 of passageway 12 received the workpiece upon which the wrench is intended to apply rotational force, about axis 14. Opening 20 of passageway 18 and/or into housing 10 is intended to receive the rest of the socket wrench tool, such as is used to transmit force to housing 10.

In the embodiment of FIG. 1, web/arm assembly 16 includes, for example, a plurality of spaced apart longitudinal arms 22, positioned circumferentially about assembly 16 and mounted within housing 10 approximately equidistant from axis 14. Although those arms have been improved upon in the present invention, the function of those arms is substantially similar to members 40 in the '467 patent, i.e., serving as cam arms to engage the workpiece and transmit rotational force thereto through flat inner surfaces 24, facing radially inward toward axis 14 (the radial directions referred to herein are with reference to axis 14). The opposing sides 26 of arms 22 are formed with a curved, camming surface for engaging a portion of the inner wall 28 of passageway 12. Arms 22 extend longitudinally along axis 14 and terminate at end faces 30 and 32. End face 30, being aligned with opening 18, can, for example, be formed with an inclined or chamfered inner surface 34 to facilitate reception of work pieces. End face 32, being interior of passageway 12 and generally sheltered from work pieces by the configuration of housing 10, can, for example, be formed with a notch 36 or be a flat face. If formed with a notch, this notch can be used to receive and retain one of the spring rings, as describe further herein with respect to the embodiment of FIG. 7. A portion 38 of the cross sectional configuration of arm 22 or a like dimension can be reduced or notched to received a spring ring mounted intermediate the length of arm 22.

In the embodiment of FIG. 1, web/arm assembly 16 also includes a first spring ring 40 and a second spring ring 50, both of which are mounted intermediate the ends of each arm 22, along portion 38. Alternatively, in certain embodiments those spring rings could be mounted to arms 22 via an interference or press fit, rather than using a dimensional reduction or notched portion 38. Each of spring rings 40 and 50 include apertures 42 and 52, respectively, for receiving arms 22. Six such apertures are illustrated, along with six corresponding arms 22, but the present invention is no limited to that number of arms. The number of arms is, preferably, established to correspond to the configuration of the work pieces which the invention is expected to be most commonly applied to. Six sided bolts being common in the United States, six arms were selected for illustration. Between each of apertures 42 and 52, spring elements or members 44 and 54, respectively, are disposed. In the embodiment of FIG. 1, these spring members are formed to be concave with respect to axis 14 (meaning that the “bend” of the spring is downward toward that axis). In contrast, the corresponding spring members in the embodiment of FIG. 7 are convex with respect to axis. However, the particular configuration of the spring can be varied as desired from one application to the next so long as the function of those springs is not adversely affected. The function of those springs is to retain arms 22 in relative position with respect to each other and to apply radial biasing force to arms 22 against motion of the arms radially away from axis 14. These spring rings are intended to improve upon and replace the function of web 36 of the '467 patent. Spring rings 40 and 50 enable web/arm assembly 16 to apply retention force to the workpiece once it is inserted into housing 10, since, in doing so, the workpiece would move arms 22 radially outward from axis 14. Thus, once inserted into housing 10, removal of the workpiece is resisted by the retention force.

Spring rings 40 and 50 serve as narrowly dimensioned biasing elements at different positions along arms 22, in contrast to the use of a single biasing element of greater width in the '467 patent. Spring rings are, preferably, spaced apart along arms 22 and held in that relation by spacer means or ring 60. Spring rings are, for example, formed from metal material, such as steel, and is preferably resistant to deformation and loss of spring temper over a significantly wide temperature range. Ring 60 may be formed of any desired material sufficient to withstand the limited compressive forces exerted upon it and the environmental forces it faces during operation of the socket wrench. Often, however, it will be most convenient to form spacer rings 60 from steel or a similar metal. If only a single spring ring is used with housing 10 in a given application, the function of spacer 60 can be provided by a step or ledge in inner wall 28 toward opening 20.

In the embodiment of FIG. 1, web/arm assembly 16 is held in place within housing 10 via a retainer ring 70. This ring also serves as a shield member to protect spring ring 40 from impact and/or contact with items entering opening 18, due to its dimensions and position adjacent and covering spring ring 40 in the direction of opening 18. Further, ring 70 serves as an abutment or stop for the workpiece upon insertion into housing 10. Ring 70 includes, for example, a plurality of radially extending projections 74 (disposed about its circumference) which can be bent slightly upon insertion into passageway 12, but which spring back out at least slightly when reaching enlargement 72 of passageway 12. In this manner, the web/arm assembly is restrained from removal from housing 10 once positioned therein during manufacture and/or servicing. Preferably, ring 70 is formed from metal material, such as steel, and is preferably resistant to deformation and loss of spring temper over a significantly wide temperature range. Ring 70 should also be formed from or coated with material sufficient to withstand the limited compressive forces exerted upon it and the environmental forces it faces during operation of the socket wrench.

Elements of the embodiment of FIG. 7 are numbered to correspond with like elements (in terms of general function) of the embodiment of FIG. 1, except for the addition of the alphanumeric “a.” The structural distinctions between the two embodiments include that housing 10a has opening 28a on opposing sides of that housing, so as to received work pieces on either side, somewhat in the manner of many conventional wrenches. Further, spring rings 40a and 50a have keyed portions 43 and 53, respectively, rather than apertures 42 and 52. Preferably, keyed portions 43 and 53 are formed to closely fit within notches 36a in arms 22a. Thus, arms 22a are engaged at their end faces by the spring rings, with no need for dimensional reduction of their cross sections intermediate the end faces (and correspondingly no need for reduction in the strength of arms 22 along their longitudinal length). Also, retainer rings 71 are of a conventional split-ring type positioned to shield and retain each of the spring rings within passageway 18a by expansion within enlargements 72a after initial compression into openings 28a. Retainer rings 71 are, for example, illustrated to work in combination to prevent removal of the web/arm assembly 16a from either end of housing 10a.

In still other alternative embodiments, the connection between the spring rings and the arms can be made via other mechanical connections, as is convenient in a given manufacturing operation or usage application, without departing from the primary functional characteristics of the present invention. In terms of the spring rings of the present invention, it is preferable in given applications that they apply radial biasing force to the arms via circumferentially continuous rings, although in a given application it may be advantageous to apply the spring biasing force via discrete and discontinuous elements, provided that the orientation of the arms is not adversely affected with respect to the camming function of applying force to the workpiece upon rotation of the wrench or tool.

As will now be understood by those of skill in the art, the spring rings of the present invention substitute spring force for compression/tension forces in radial biasing of longitudinal arms 22, by comparison with the invention described in the '467 patent. Those spring forces are directed to and between each pair of circumferentially adjacent arms, and may permit, in a given instance, greater differential in the radial biasing forces applied to given arms 22, according to uneven configurations of the workpiece circumference entering the tool housing. Moreover, the use of a pair of spring rings as the radial biasing means permits the security of system redundancy in the event of a partial failure or failure of a single spring ring.

Although the present invention has been described herein with respect to specific embodiments, it must be understood that was done by way of illustration and example. The spirit and scope of the present invention is intended to be limited only by the scope of the following claims.

What is claimed is:

1. An assembly for retaining a plurality of longitudinally extending arms, for engaging a workpiece, and applying radially extending biasing force to said arms to urge engagement with a workpiece, comprising:
a first biasing element, connected to said arms,
a second biasing element, connected to said arms at a location spaced apart from said first biasing element along the longitudinal length of said arms, and
each of said biasing elements having means to apply spring-based force to resist radial movement of said arms.

2. The assembly according to claim 1 as mounted within a hand tool for applying rotational force to a workpiece.

3. The assembly according to claim 2 wherein:
the arms have a flat surface thereon which is engageable with the workpiece when the workpiece is inserted within the hand tool,
the arms provide retention force to the workpiece when the workpiece is inserted within the hand tool, and
rotational force is applied to the workpiece through those arms so as to cause rotation of the workpiece.

4. The assembly according to claim 1 wherein the arms are arranged to be spaced apart about the circumference of the workpiece expected for use with the assembly, and each of the biasing elements includes separately formed spring members as said means to apply spring-based force and to resist radial movement of each of the arms, those spring force members being connected between pairs of circumferentially adjacent arms.

5. The assembly according to claim 4 wherein the first and second biasing means are separated by a spacer means extending along the longitudinal length of said arms.

6. The assembly according to claim 5, as mounted into a housing having a passageway extending at least partially therethrough, that passageway having an opening for receiving a workpiece, and the assembly further including a shield member disposed between said opening and the biasing elements so as to restrict access to the biasing elements from items passing through said opening.

7. The assembly according to claim 1 wherein:
said arms have an end face at each terminus of the longitudinal length of the arms, and
at least one of said biasing elements is connected to the arms at one of the end faces of those arms.

8. The assembly according to claim 7 wherein one of said biasing elements is connected to the arms intermediate the end faces of those arms.

9. The assembly according to claim 8 wherein the assembly is mounted into a housing having a passageway extending at least partially therethrough, that passageway having an opening for receiving a workpiece, and the biasing element connected to the arms intermediate the end faces is disposed closer to said opening than the biasing element connected at the end faces, and the assembly further includes a retaining element disposed between the biasing element connected to the arms intermediate the end faces and said opening which restricts removal of the assembly from the housing.

10. The assembly according to claim 9 wherein the biasing elements are formed as continuous rings with apertures therein to receive the arms about the circumference of those rings, and the retaining element is formed as a ring with projections about its circumference for engaging the surface of the passageway.

11. The assembly according to claim 10 wherein the retaining element is disposed within the housing such that it restricts contact between the biasing elements and the workpiece, and the retaining element is formed from a material that is sufficiently heat resistant that the thermal gradient between the workpiece temperature and the temperature of the biasing elements does not adversely affect the biasing elements.

12. The assembly according to claim 11 wherein the housing forms a portion of a socket wrench.

13. The assembly according to claim 1 wherein the biasing elements are formed from material that is sufficiently heat resistant that the thermal gradient between the workpiece temperature and the temperature of the biasing elements does not adversely affect the biasing element.

14. The assembly according to claim 7 wherein:
each end face of each of the arms includes a notched portion,
the biasing elements are each formed as continuous rings,
the biasing elements include keyed portions spaced apart about those rings which are formed to closely fit into the notched portions of the arms and retain the arms to the rings,
the assembly is mounted within a housing,
said housing has a passageway therethrough for receiving the assembly,
the assembly further includes retainer rings for engaging the passageway on either side of the assembly to restrict removal of the assembly from the passageway, and
the retainer rings are disposed and configured within the passageway so as to also restrict contact between the workpiece and the biasing elements when a workpiece is received within the passageway.

15. The assembly according to claim 14 wherein the housing forms a portion of a hand wrench.
